(19) United States
(12) Patent Application Publication
(10) Pub. No.: US 2006/0226763 A1
(43) Pub. Date: Oct. 12, 2006

(54) Display device with electron emitters and method for making the same

(76) Inventors: Hee-Sung Moon, Suwon-si (KR); Jae-Myung Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/401,715

(22) Filed: Apr. 11, 2006

(30) Foreign Application Priority Data
Apr. 12, 2005 (KR) 10-2005-0030363

(51) Int. Cl. H01J 63/04

(52) U.S. Cl. 313/495; 313/310; 313/311; 313/309

(57) ABSTRACT

An display device and a method of making the display device are disclosed. The electron emitter is coated with metal oxide nanoparticles. The display device includes an electron emitter. The electron emitter has carbon particles and metal oxide particles. The carbon particles have surfaces and at least part of the metal oxide particles is formed on at least part of the surfaces of the carbon particles. When the carbon nanotubes having coated outer walls are used in the electron emitter, electron emission occurs in carbon nanotube tips and the coated outer walls, which increases an electron emitting region and conductivity of the carbon nanotubes due to coating particles when adjacent carbon nanotubes come into contact with each other.

### CROSS-REFERENCE TO RELATED PATENT APPLICATION

This application claims the benefit of Korean Patent Application No. 10-2005-0030363, filed on Apr. 12, 2005, in the Korean Intellectual Property Office, the disclosure of which is incorporated herein by reference in its entirety.

### BACKGROUND OF THE INVENTION

1. Field of the Invention

The present invention relates to an electronic device, and more particularly, to an electron emitter and a display device with the electron emitter.

1. Description of the Related Art

An electron emission device is a display device using electron emissions to trigger generation of visual light and display of an image. Electrons are emitted from an electric emitter toward pixel phosphors when a voltage is applied between an anode and a cathode to form an electric field therebetween. The electrons emitted from the electron emitter collide into the fluorescent or phosphor material, which emits visual light.

Japanese Patent Laid-Open Publication Nos. 1999-233008 and 2002-216614 use a PdO thin film pattern in the electron emitter.

### SUMMARY OF CERTAIN INVENTIVE ASPECTS

One aspect of the invention provides an electronic device, which may comprise: a substrate; a cathode formed over the substrate and; an electron emitter electrically connected to the cathode, the electron emitter comprising carbon particles and metal oxide particles, wherein the carbon particles have surfaces, and wherein at least part of the metal oxide particles is formed on at least part of the surfaces of the carbon particles.

The electronic device may comprise a display device. The electronic device may further comprise: an anode comprising a surface; and a phosphor layer over the surface of the anode, wherein the electron emitter comprises a surface generally facing the phosphor layer.

In the foregoing device, the carbon particles may comprise one or more selected from the group consisting of carbon tubes, carbon spheres, carbon ellipsoids, graphite and diamond.

Still in the foregoing device, the metal oxide particles may comprise at least one selected from the group consisting of PdO, ZnO and TiO₂. The metal oxide particles may have an average particle diameter of about 100 nm or less. The metal oxide particles may have an average particle diameter of about 5 nm or less.

Another aspect of the invention provides a method of making an electronic device, which may comprise: providing a substrate; and forming an electron emitter over the substrate, the electron emitter comprising carbon particles and metal oxide particles, wherein the carbon particles have surfaces, and wherein at least part of the metal oxide particles is formed on at least part of the surfaces of the carbon particles.

The carbon particles may comprise one or more selected from the group consisting of carbon tubes, carbon spheres, carbon ellipsoids, graphite and diamond. The metal oxide particles may comprise one or more selected from the group consisting of PdO, ZnO and TiO₂.

Still in the foregoing method, forming the electron emitter may comprise: providing a composition comprising the carbon particles, the metal oxide particles and a solvent; forming a pattern over the substrate with the composition; and calcining the pattern. Forming the electron emitter may further comprise activating the electron emitter. At least part of the metal oxide particles may be attached on at least part of the surface. The composition may further comprise at least one additive selected from the group consisting of a binder, a filler, a photosensitive resin, a photoinitiator, a leveling agent, a thickener, a resolution improving agent, a dispersant and an antifoaming agent. The metal oxide particle precursor may comprise one or more selected from the group consisting of Pd(NO₃)₂, Zn(NO₃) and Ti(NO₃)₄.

Further in the foregoing method, providing the composition may comprise: mixing the carbon particles, metal oxide particle precursor to form a mixture; and heating the mixture under an atmosphere comprising oxygen so as to convert at least some of the metal oxide particle precursor to metal oxide particles. Heating the mixture may comprise subjecting the mixture to a temperature from about 200 to about 300° C. Calcining the pattern may comprise subjecting the pattern to a temperature from about 400 to about 500° C.

Still another aspect of the present invention provides a display device produced by the foregoing method.

Further aspect of the present invention provides an electron emitter having an outer wall coated with metal oxide nanoparticles to increase an electron emitting region and increase conductivity due to coating particles when adjacent carbon nanotubes (CNTs) come into contact with each other, and an electron emission device comprising the electron emitter. The electron emitter may be coated with metal oxide nanoparticles.

According to another aspect of the present invention, a method of preparing an electron emitter includes preparing an electron emitter forming composition including a carbon-based material, a metal oxide nanoparticle precursor, and a vehicle or a carrier; performing a thermal treatment on the electron emitter forming composition under an oxygen atmosphere; printing the thermal treated electron emitter forming composition on a substrate; calcining the printed electron emitter forming composition; and activating the resultant to obtain an electron emitter.

According to another aspect of the present invention, an electron emission device includes: a substrate; a cathode formed on the substrate; and an electron emitter electrically connected to the cathode.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of an electron emitter according to an embodiment of the present invention, showing a carbon particle and metal oxide particles; and

FIG. 2 is a schematic cross-sectional view of an electron emission device according to an embodiment of the present invention.

### DETAILED DESCRIPTION OF EMBODIMENTS

Hereinafter, various features of the present invention will now be described in detail in terms of embodiments and examples with reference to the accompanied drawings.

Carbon based materials including CNTs have excellent electronic conductivity and can be used in the electron emitter to provide a large area with good conductivity and electric field concentration effect, low work function, and good field emission characteristics. Thus, the carbon based materials are expected as an ideal electron emitter of the electron emission device.

However, the carbon-based materials including CNTs may have insufficient electron emission ability as most of field emission appears to occur only in tips or ends of CNTs having large field enhancement factor.

An electron emitter according to an embodiment of the present invention has carbon particles with outer walls or surfaces on which certain metal oxide nanoparticles are formed.

In embodiments of the invention the electron emitter includes a carbon-based material or carbon particles. The carbon-based material has good conductivity and electron emission properties, and thus emits electrons toward a phosphor layer of an anode to excite a phosphor when an electron emission device is operated. Examples of the carbon-based material include, but are not limited to, CNTs, graphite, diamond, and fullerenes.

In embodiments, these carbon-based materials in particulate forms with one or more surfaces, on which metal oxide particles can be formed. In certain embodiments, the carbon-based material includes a single wall carbon nanotube (SWCNT) or a multi wall carbon nanotube (MWCNT).

A CNT is a carbon allotrope, which can be prepared by, for example, rolling a graphite sheet to form a tube shape with a nano-scope diameter. The resulting CNTs can be a SWCNT or a MWCNT. The CNTs may also be prepared using chemical vapor deposition (CVD) such as thermal CVD, DC plasma CVD, RF plasma CVD, or microwave plasma CVD. The skilled artisan will understand these various methods to prepare CNTs and other carbon-based material appropriate for the embodiments of the invention.

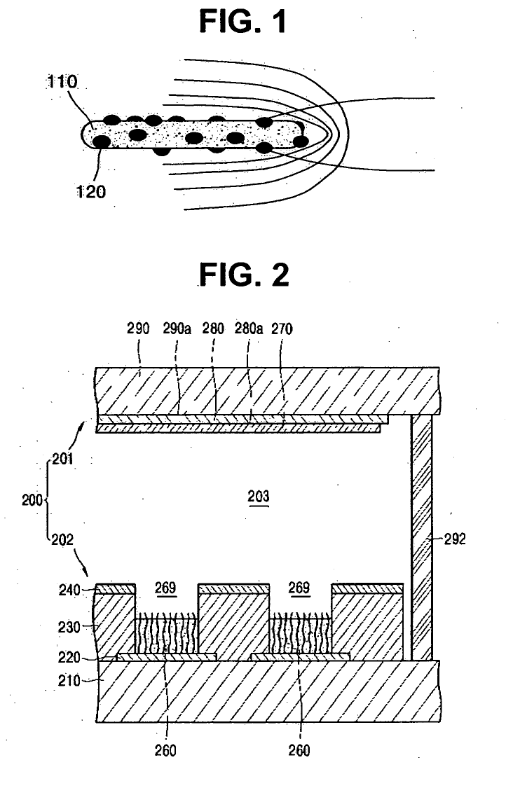

The electron emitter according to an embodiment of the present invention can be prepared by forming metal oxide nanoparticles on an outer wall or surface of the CNT or other carbon-based material. Referring to FIG. 1, the electron emitter according to an embodiment of the present invention has a CNT 110 having an outer surface with metal oxide nanoparticles 120 thereon. The metal oxide particles may be firmly attached on to the surface or loosely bound to the surface. Some metal oxide particles may be formed in spaces between or among two or more carbon particles. On surfaces of certain carbon particles, many metal oxide particles may substantially cover the surfaces, such as the metal oxide particles are coated on the surfaces. On other carbon particles, metal oxide particles may be scattered relatively sparsely. The metal oxide particles may be nano-size-particles. The metal oxide particles include, for example, PdO, ZnO and TiO₂. Although not listed, numerous other metal oxides can be used with carbon-based material. The skilled artisan in the appropriate technical field will appreciated may other metal oxides. The metal oxides can be used alone or as a mixture of two or more different metal oxides.

According to quantum mechanical calculation, the metal oxide nanoparticles can improve the electron emission ability of CNT or other carbon-based material when they are formed on an outer wall or surfaces thereof. Although the invention is not bounded by any theories of science, one likely explanation is that the metal oxide particles change the surface conduction band to a Fermi level due to an electric field in an energy diagram. In one embodiment, the metal oxide nanoparticles have an average particle diameter of 100 nm or less, and optionally, 5 nm or less.

A method of preparing an electron emitter according to an embodiment of the present invention includes: preparing a composition for the electron emitter; thermal treating the composition under an oxygen atmosphere; printing or depositing the thermal treated composition on a substrate; calcining the composition; and activating the resultant to obtain an electron emitter. In the method, the composition includes a carbon-based material and a precursor of the metal oxide particles.

In one embodiment, the electron emitter forming composition including a carbon-based material or carbon particles, a metal oxide nanoparticle precursor, and a vehicle or carrier is prepared.

An exemplary metal oxide nanoparticle precursor is Pd(NO₃)₂, Zn(NO₃), Ti(NO₃)₄, or a mixture thereof. The precursor will be transformed metal oxide nanoparticles such as PdO, ZnO, and TiO₂ through thermal treatment under an oxygen atmosphere.

The vehicle or carrier in the electron emitter forming composition controls the printability and viscosity of the electron emitter forming composition. Typically the vehicle includes a polymer and a solvent. Examples of the polymer include, but are not limited to, a cellulose-based resin such as ethyl cellulose, nitro cellulose, etc.; acrylic resin such as polyester acrylate, epoxy acrylate and urethane acrylate; and a vinyl-based resin. The solvent may be, but is not limited to, butyl carbitol acetate (BCA), terpineol (TP), toluene, texanol, and butyl carbitol (BC) or so, which are able to dissolve a carbon-based material, a metal oxide nanoparticle, and polymers.

In some embodiments, the electron emitter forming composition may further include at least one additive such as a binder, a filler, a photosensitive resin, a photoinitiator, a leveling agent, a thickener, a resolution improving agent, a dispersant, and an antifoaming agent. The binder is to improve the adhesion of a carbon-base material to a substrate and may be at least one selected from the group consisting of an inorganic adhesive, an organic adhesive, and a metal having low melting point. The filler is to improve the conductivity of the carbon-based material which may not sufficiently contact the underlying substrate which can be the cathode. Examples of the filler include, but are not limited to, Ag, Al, and Pd.

The photosensitive resin is to pattern an electron emitter over the substrate. Examples of the photosensitive resin include, but are not limited to, a thermally degradable acrylate-based monomer, a benzophenone-based monomer, an acetophenone-based monomer and a thioxanthone-based monomer. More specifically, epoxy acrylate, polyester acrylate, 2,4-diethyloxanthone, or 2,2-dimethoxy-2-phenylacetophenone can be used. The photoinitiator initiates cross-linking of the photosensitive resin when the photosensitive resin is exposed to light. An example of the photoinitiator includes, but is not limited to, benzophenone. The leveling agent is to decrease the surface tension of the carbon-base material after printing or depositing to improve a leveling property of components included in the electron emitter forming composition. The electron emitter having an improved leveling property has a good luminous uniformity, and an electric field can be uniformly applied thereto, thereby increasing the lifespan of the electron emitter. The electron emitter forming composition may further include a thickener, a resolution improving agent, a dispersant, and an antifoaming agent, if necessary.

In the above described method, the electron emitter forming composition is subjected to a thermal treatment under an oxygen atmosphere, which causes at lease some of the precursor to transform metal oxide nanoparticles. The thermal treatment can be carried out at a temperature from about 200 to about 300° C.

Next, the prepared electron emitter forming composition is printed, coated or deposited on a substrate by a method appropriate to form a layer of the composition on a substrate. A process of printing the electron emitter forming composition can vary depending on whether the composition includes a photosensitive resin or not. In one embodiment, when the electron emitter forming composition includes a photosensitive resin, an additional photoresist pattern may not be required. A layer of the composition including a photoresist resin is formed on a substrate, and then the regions of the layer to form the electron emitter are selectively exposed to light and developed. On the other hand, in another embodiment, when the electron emitter forming composition does not include a photosensitive resin, a photolithography process using an additional photoresist pattern may be required. The photoresist pattern is formed using a photoresist film, and then the composition is selectively formed on the substrate using the photoresist pattern.

As described above, through the calcining process, an adhesion force between the carbon-based material and the substrate can be improved. At least some of the binder can be melted and solidified, which may improve durability of an electron emitter. The outgassing may be minimized. The calcining temperature may be determined considering the evaporability of the above described solvent and the temperature and time to complete the sintering of the binder. The calcining temperature may be from about 400 to about 500° C., and preferably about 450° C.

In one embodiment, the carbon-based material on the surface of the calcined resultant is subjected to an activation process. In an embodiment of the activation process, a liquid material which can be hardened into a solid film form formed on the calcined layer. For example, the liquid material may be solidified through heat treatment. For example, the material includes a polyimide-based polymer. Once the liquid material is formed in the calcined layer, it is solidified into film by, for example, a heat-treatment. Then the film is peeled off. In another embodiment of the activation process, an a roller having an adhesive surface is rolled on the surface of the calcined resultant with a predetermined pressure. Through this activation process, certain releasable materials on the clacined layer are removed therefrom, and the carbon-based material or carbon particles can be exposed. Also the activation process orients the carbon particles in a certain direction to effectively emit electrons therefrom.

An electron emission device, display device or field emission display according to another embodiment of the present invention includes: a substrate; a cathode formed on the substrate; and an electron emitter electrically connected to the cathode. The electron emitter includes carbon particles with one or more surfaces and metal oxide formed on at lease some of the surface.

FIG. 2 is a schematic cross-sectional view of a triode electron emission device according to another embodiment of the present invention. Referring to FIG. 2, an electron emission device 200 includes an upper plate 201 and a lower plate 202. The upper plate 201 includes an upper substrate 290, an anode 280 placed on a lower surface 290a of the upper substrate 290, and a phosphor layer 270 placed on a lower surface 280a of the anode 280.

The lower plate 202 includes: a lower substrate 210 placed at a predetermined distance facing the upper substrate 290; a cathode 220 placed on the lower substrate 210 in a stripe extending in a direction passing through the sheet of the drawing; a gate electrode 240 placed in a stripe form so as to cross the strip of the cathode 220; an insulating layer 230 interposed between the gate electrode 240 and the cathode 220; an electron emitter hole 269 formed in the insulating layer 230 and the gate electrode 240; and an electron emitter 260 placed in the electron emitter hole well 269, electrically connected to the cathode well 220, and having a height lower than the gate electrode 240.

The upper plate 201 and the lower plate 202 are kept in vacuum at a pressure lower than atmospheric pressure and a spacer 292 was interposed between the upper plate 201 and the lower plate 202 so as to support the upper plate 201 and the lower plate 202 and divide an emission space 203.

The anode 280 applies a high voltage required to accelerate electrons emitted from the electron emitter 260 so as to allow the electrons to collide into the phosphor layer 270 at high speed. The phosphor layer 270 is excited by emitted electron and then the energy level thereof drops to a low level, thereby emitting visible rays. In the case of a color electron emission device, red, green, and blue phosphor layers formed in a plurality of emission spaces 203, which provide unit pixels, are placed on the lower surface 280a of the anode 280.

The gate electrode 240 allows electrons to be easily emitted from the electron emitter 260. The insulating layer 230 separates the electron emitter hole 269 from the neighboring hole wells 269 and insulates between the electron emitter 260 and the gate electrode 240.

The present invention will now be described in greater detail with reference to the following example. The following example is are for illustrative purposes only and are not intended to limit the scope of the invention.

### EXAMPLE 1

### Manufacture of Electron Emission Device According to the Present Invention

1.632 g of Pd(NO₃)₂ as a metal oxide nanoparticle precursor and carbon nanotubes were mixed together and subjected to a thermal treatment under an oxygen atmosphere. 1 g of a coated carbon nanotube powder (MWNT, available from Iljin Nanotech Co, Ltd.), 0.2 g of a frit (8000 L, available from Shinheung Ceramic Ind. Co., Ltd.), 3 g of acrylic resin (Elvacite, available from Lucite International Inc.), and 5 g of polyester acrylate, 5 g of benzophenone were added to 10 g of terpineol and stirred, and then 2 g of dioctyl phthalate (available from Sigma-Aldrich Co.) as a plasticizer was further added to the carbon nanotube and metal oxide mixture and mixed to prepare an electron emitter forming composition with the viscosity of 30,000 cps.

The electron emitter forming composition was formed on a substrate having a Cr gate electrode, an insulating layer and an ITO electrode. Then, light with exposure energy of 2000 mJ/cm2 was irradiated thereto using a pattern mask and a parallel exposure system. Then, the exposed electron emitter pattern was developed by spraying acetone. The pattern was calcined at 450° C. to form an electron emitter. The formed electron emitter was pressed with a roller having an adhesive surface, and then separated from the roller and activated to obtain a final electron emitter. Thereafter, a substrate having a phosphor layer and an ITO layer as an anode was placed so as to face the substrate having the electron emitter formed thereon and a spacer was interposed between both substrates to maintain a gap between substrates, thereby completing an electron emission device.

When carbon particles such as CNTs with metal oxide particles formed on the outer walls or surfaces of the carbon particles are used as an electron emitter, electron emission occurs in tips of carbon particles and the coated outer walls, which increases an electron emitting region and conductivity of the carbon particles particularly more so when adjacent carbon particles come into contact with each other. Therefore, an electron emitter having improved electron emission ability and an electron emission device comprising the same can be provided.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electronic device, comprising:
a substrate;
a cathode formed over the substrate; and
an electron emitter electrically connected to the cathode, the electron emitter comprising carbon particles and metal oxide particles, wherein the carbon particles have surfaces, and wherein at least part of the metal oxide particles is formed on at least part of the surfaces of the carbon particles.

2. The device of claim 1, wherein the electronic device comprises a display device.

3. The device of claim 2, further comprising:
an anode comprising a surface; and
a phosphor layer over the surface of the anode, wherein the electron emitter comprises a surface generally facing the phosphor layer.

4. The device of claim 1, wherein the carbon particles comprise one or more selected from the group consisting of carbon tubes, carbon spheres, carbon ellipsoids, graphite and diamond.

5. The device of claim 1, wherein the metal oxide particles comprise at least one selected from the group consisting of PdO, ZnO and TiO₂.

6. The device of claim 1, wherein the metal oxide particles have an average particle diameter of about 100 nm or less.

7. The device of claim 1, wherein the metal oxide particles have an average particle diameter of about 5 nm or less.

8. A method of making an electronic device, the method comprising:
providing a substrate; and
forming an electron emitter over the substrate, the electron emitter comprising carbon particles and metal oxide particles, wherein the carbon particles have surfaces, and wherein at least part of the metal oxide particles is formed on at least part of the surfaces of the carbon particles.

9. The method of claim 8, wherein the carbon particles comprise one or more selected from the group consisting of carbon tubes, carbon spheres, carbon ellipsoids, graphite and diamond.

10. The method of claim 8, wherein the metal oxide particles comprise one or more selected from the group consisting of PdO, ZnO and TiO₂.

11. The method of claim 8, wherein forming the electron emitter comprises:
providing a composition comprising the carbon particles, the metal oxide particles and a solvent;
forming a pattern over the substrate with the composition; and
calcining the pattern.

12. The method of claim 11, wherein forming the electron emitter further comprises activating the electron emitter.

13. The method of claim 11, wherein at least part of the metal oxide particles are attached on the at least part of the surfaces.

14. The method of claim 11, wherein the composition further comprises at least one additive selected from the group consisting of a binder, a filler, a photosensitive resin, a photoinitiator, a leveling agent, a thickener, a resolution improving agent, a dispersant and an antifoaming agent.

15. The method of claim 11, wherein the metal oxide particle precursor comprises one or more selected from the group consisting of Pd(NO₃)₂, Zn(NO₃) and Ti(NO₃)₄.

16. The method of claim 11, wherein providing the composition comprises:
mixing the carbon particles, metal oxide particle precursor to form a mixture; and
heating the mixture under an atmosphere comprising oxygen so as to convert at least some of the metal oxide precursor to metal oxide particles.

17. The method of claim 1, wherein the metal oxide particles have an average particle diameter of about 100 nm or less.

18. The method of claim 1, wherein the metal oxide particles have an average particle diameter of about 5 nm or less.

19. A display device produced by the method of claim 8.
